(19) United States
(12) Patent Application Publication
(10) Pub. No.: US 2026/0100658 A1
(43) Pub. Date: Apr. 9, 2026

(54) ONE-HALF-AND-HALF REDUNDANT MOTOR CONTROLLER

(71) Applicant: Steering Solutions IP Holding Corporation, Saginaw, MI (US)

(72) Inventors: Payam Ramezani-Badr, Midland, MI (US); Robby L. Linton, Saginaw, MI (US); Krishna MPK Namburi, Troy, MI (US)

(21) Appl. No.: 19/338,413

(22) Filed: Sep. 24, 2025

Related U.S. Application Data
(60) Provisional application No. 63/704,738, filed on Oct. 8, 2024.

(51) Int. Cl. H02M 7/483; B62D 5/04; H02M 1/00; H02M 7/537

(52) U.S. Cl. CPC H02M 7/483; B62D 5/0409; B62D 5/0463; H02M 1/0012; H02M 1/0067; H02M 7/537

(57) ABSTRACT

A motor controller for a dual-wound motor includes: a first ECU including at least one first microcontroller unit (MCU), a first inverter having first output switches configured to supply a first AC power to a first winding set of the dual-wound motor, and a second inverter having second output switches configured to supply a second AC power to the second winding set of the dual-wound motor; a second ECU including a secondary MCU and a third inverter having third output switches configured to supply a third AC power to a second winding set of the dual-wound motor; and a gate logic switch selectively enabling each of the second output switches of the second inverter to be controlled by either of the at least one primary MCU or the secondary MCU and selectively enabling the third output switches of the third inverter to be controlled by either of the at least one primary MCU or the secondary MCU.

### CROSS REFERENCE TO RELATED APPLICATIONS

This U.S. utility patent application claims the benefit of U.S. Provisional Patent Application No. 63/704,738, filed Oct. 8, 2024, the contents of which is incorporated herein by reference in its entirety.

### TECHNICAL FIELD

This disclosure relates to a redundant motor controller for a dual-wound motor.

### BACKGROUND

Automotive safety-critical applications, such as vehicle steering, may be required to follow ISO26262 ASIL-D standards both at a system level and for electrical and electronic (E/E) components. Such standards may be applicable to electric power steering and steer-by-wire (EPS/SbW) actuators. Safety criticality of steering applications may necessitate redundant designs to minimize the possibility of a single-point-of-failure and ensure resilient operation under most circumstances. A minimum assist torque may be required, even in the most extreme fault situations such as battery short circuit and multiple E/E failures in the system. Depending on the number of batteries available in a vehicle, variations of dual-redundant (per actuator), and quad-redundant architectures may be implemented with circuits to transfer power from multiple available batteries to keep required functionalities online under stringent design failure mode effects and analysis (DFMEAs). On approach to meet this goal is a primary-dependent design, in which a primary electrical control unit (ECU) normally executes control for one or more dependent ECUs. Consequently, the dependent ECUs may have lower operating complexity and can be designed with simpler E/E circuitry.

### SUMMARY

An aspect of the disclosed embodiments includes a motor controller for a dual-wound motor having a first winding set and a second winding set isolated from the first winding set. The motor controller includes: a primary electronic control unit (ECU), a secondary ECU, and a gate logic switch. The primary ECU includes at least one first microcontroller unit (MCU), a first inverter having a first plurality of output switches configured to supply a first alternating current (AC) power to the first winding set of the dual-wound motor, and a second inverter having a second plurality of output switches configured to supply a second AC power to the second winding set of the dual-wound motor. The secondary ECU includes a secondary MCU and a third inverter having a third plurality of output switches configured to supply a third AC power to the second winding set of the dual-wound motor. The gate logic switch is configured to selectively enable each of the second plurality of output switches of the second inverter to be controlled by either of the at least one primary MCU or the secondary MCU and to selectively enable each of the third plurality of output switches of the third inverter to be controlled by either of the at least one primary MCU or the secondary MCU.

Another aspect of the disclosed embodiments includes a motor control system. The motor control system includes: a dual-wound motor having a first winding set and a second winding set isolated from the first winding set; a primary electronic control unit (ECU), a secondary ECU, and a gate logic switch. The primary ECU includes at least one first microcontroller unit (MCU), a first inverter having a first plurality of output switches configured to supply a first alternating current (AC) power to the first winding set of the dual-wound motor, and a second inverter having a second plurality of output switches configured to supply a second AC power to the second winding set of the dual-wound motor. The secondary ECU includes a secondary MCU, and a third inverter having a third plurality of output switches configured to supply a third AC power to the second winding set of the dual-wound motor. The gate logic switch is configured to selectively enable each of the second plurality of output switches of the second inverter to be controlled by either of the at least one primary MCU or the secondary MCU and to selectively enable each of the third plurality of output switches of the third inverter to be controlled by either of the at least one primary MCU or the secondary MCU.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows a schematic diagram of an electric power steering (EPS) system according to the principles of the present disclosure.

FIG. 2 presents schematic block diagram of a motor drive system according to the principles of the present disclosure.

FIGS. 3A-3B show a schematic wiring diagram of two logic boards of the motor drive system of the present disclosure.

FIGS. 4A-4B show a schematic wiring diagram of two logic boards of the motor drive system of the present disclosure.

FIG. 5 shows schematic diagrams of two consensus and arbitration controllers of the two logic boards of the motor drive system of the present disclosure.

FIG. 6 shows an electrical schematic diagram showing the inverters of the motor drive system of the present disclosure configured to supply power to the dual-wound motor.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present disclosure provides a novel redundant primary-dependent steering actuator controller design that fills the cost/performance gap between the dual and quad redundant architectures, and offers verifiable advantages compared to a hypothetical triple redundant system. The one-half-and-half (OHH) redundant motor controller of the present disclosure may be applied to safety-critical applications where redundancy is required.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electric power steering system (EPS) system, an SbW steering system, a hydraulic steering system, or other suitable steering system. The steering system of such a vehicle typically controls various aspects of vehicle steering including providing steering assist to an operator of the vehicle, controlling steerable wheels of the vehicle, and the like.

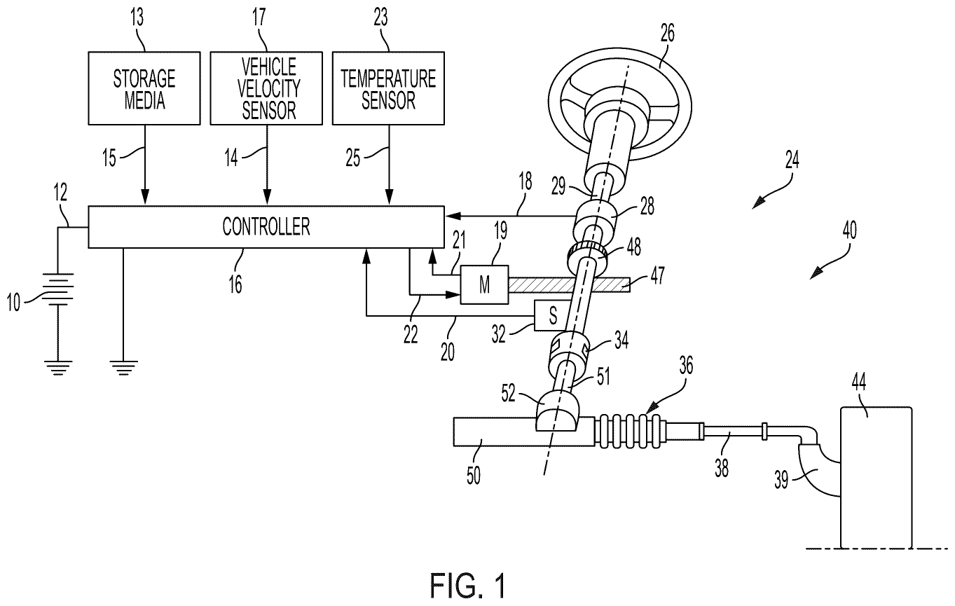

FIG. 1 is a schematic diagram of an EPS system 40 suitable for implementation of the disclosed techniques. The EPS system 40 includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motion control system 24 and includes a steering electronic control unit (ECU) 16 and an electric motor 19. The steering ECU 16 is powered by the vehicle power supply 10 through supply conductors 12. The steering ECU 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the steering ECU 16 a position signal 20. Motor velocity may be measured with a tachometer, or any other device, and transmitted to the steering ECU 16 as a velocity signal 21. A motor velocity denoted ωₘ may be measured, calculated or a combination thereof. For example, the motor velocity ωₘ may be calculated as the change of the motor position as measured by a position sensor 32 over a prescribed time interval. For example, motor speed ωₘ may be determined as the derivative of the motor position θₘ with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to the steering ECU 16 in relation to the amount of twist on the torsion bar. Although this is one type of torque sensor, any other suitable torque-sensing device used with known signal processing techniques will suffice. In response to the various inputs, the controller sends a command 22 to the electric motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motion control system 24 as depicted, the steering ECU 16 utilizes the torque, position, and speed, and like, to compute a command(s) to deliver the required output power. The steering ECU 16 is disposed in communication with the various systems and sensors of the motor control system. Steering ECU 16 receives signals from each of the system sensors, quantifies the received information, and provides an output command signal(s) in response thereto, in this instance, for example, to the electric motor 19. Steering ECU 16 is configured to develop the corresponding voltage(s) out of inverter (not shown), which may optionally be incorporated with steering ECU 16 and will be referred to herein as steering ECU 16, such that, when applied to the electric motor 19, the desired torque or position is generated. In one or more examples, the steering ECU 16 operates in a feedback control mode, as a current regulator, to generate the command 22. Alternatively, in one or more examples, the steering ECU 16 operates in a feedforward control mode to generate the command 22. Because these voltages are related to the position and speed of the electric motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the electric motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the electric motor 19. Preferably, the temperature sensor 23 is configured to directly measure the temperature of the sensing portion of the electric motor 19. The temperature sensor 23 transmits a temperature signal 25 to the steering ECU 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the steering ECU 16. The steering ECU 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), steering ECU 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, steering ECU 16 may include input signal processing and filtering to enable accurate sampling and conversion or acquisitions of such signals from communications interfaces.

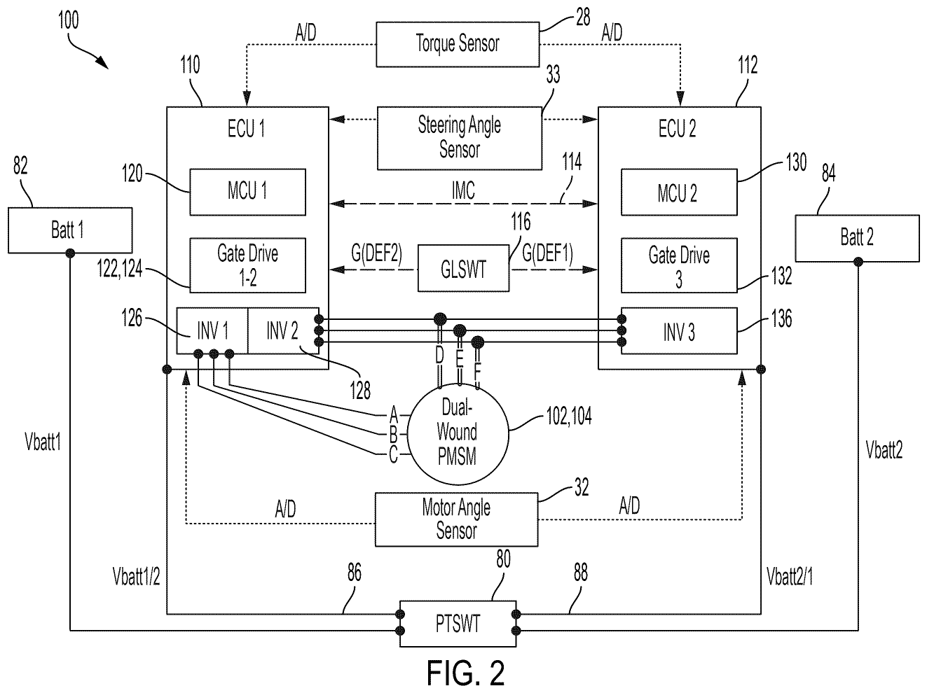

FIG. 2 presents schematic block diagram of a motor drive system 100 according to the principles of the present disclosure. The motor drive system 100 shown on FIG. 2 implements a One-Half-and-Half (OHH) controller to provide redundant operation of a dual-wound motor 102, 104 having a first winding set 102 and a second winding set 104 that is isolated from the first winding set. The first winding set 102 includes terminals labeled ABC, and the second winding set 104 includes terminals labeled DEF. The dual-wound motor 102, 104 may be a three-phase dual-wound permanent magnet synchronous machine (DWPMSM). However, the motor drive design of the present disclosure may be used with other types of dual-wound motor and/or a dual-wound motor with a different number of phases.

The motor drive system 100 includes a first electronic control unit (ECU) 110, which may also be called ECU1. The motor drive system 100 also includes a second ECU2 112, which may also be called ECU2. As shown, the first ECU 110 may communicate directly with the second ECU 112 via an inter-microcontroller communications (IMC) interface 114. The motor drive system 100 also includes a gate logic switch 116, which may also be called GLSWT.

The first ECU 110 includes a primary microcontroller unit (MCU) 120 which may also be called MCU1. The first ECU 110 also includes a first inverter 126 that is configured to supply a first alternating current (AC) power to the first winding set 102 of the dual-wound motor 102, 104. The first ECU 110 also includes a second inverter 128 that is configured to supply a second AC power to the second winding set 104 of the dual-wound motor 102, 104. The first ECU 110 includes a first gate driver 122 that is configured to control operation of a first plurality of output switches in the first inverter 126. The first ECU 110 also includes a second gate driver 124 that is configured to control operation of a second plurality of output switches in the second inverter 128.

The second ECU 112 includes a secondary MCU 130 which may also be called MCU2. The second ECU 112 also includes a third inverter 136 that is configured to supply a third AC power to the second winding set 104 of the dual-wound motor 102, 104. The second ECU 112 includes a third gate driver 132 that is configured to control operation of a third plurality of output switches in the third inverter 136.

As also shown on FIG. 2, each of the torque sensor 28, the position sensor 32, which may also be called a motor angle sensor, and a steering angle sensor 33 are in communication with each of the first ECU 110 and the second ECU 112. The position sensor 32 and the steering angle sensor 33 may measure angular positions on either of two opposite ends of a torque bar that twists in response to a torque application. Each of the ECUs 110, 112 may independently determine applied torque based on a difference between signals from the position sensor 32 and the steering angle sensor 33.

As also shown on FIG. 2, the motor drive system 100 includes a power transfer switch 80 that is connected to a first battery 82 and a second battery 84. The power transfer switch 80 may be configured to supply power to each of the first ECU 110 and/or the second ECU 112 from either or both of the first battery 82 and/or the second battery 84. The power transfer switch 80 supplies power to the first ECU 110 via a first DC supply conductor 86, which may be called Vbatt1/2. The power transfer switch 80 also supplies power to the second ECU 112 via a second DC supply conductor 88, which may be called Vbatt2/1. In case the first battery 82 becomes discharged or disconnected, the power transfer switch 80 may cause both of the first ECU 110 and the second ECU 112 to receive power from the second battery 84. In case the second battery 84 becomes discharged or disconnected, the power transfer switch 80 may cause both of the first ECU 110 and the second ECU 112 to receive power from the first battery 82. The power transfer switch 80 may default to supplying power from the first battery 82 to the first ECU 110 and to supplying power from the second battery 84 to the second ECU 112. However, the power transfer switch 80 may be configured differently. For example, the power transfer switch 80 may default to supplying power from the first battery 82 to both the first ECU 110 and the second ECU 112, and the second battery 84 may be used only as a backup, in case the first battery 82 becomes discharged or otherwise unavailable.

Alternatively, the OHH motor drive may be operated without a power transfer switch 80. For example, the first ECU 110 and the second ECU 112 may each be supplied power directly from corresponding independent direct current (DC) power sources, such as the first battery 82 and/or the second battery 84.

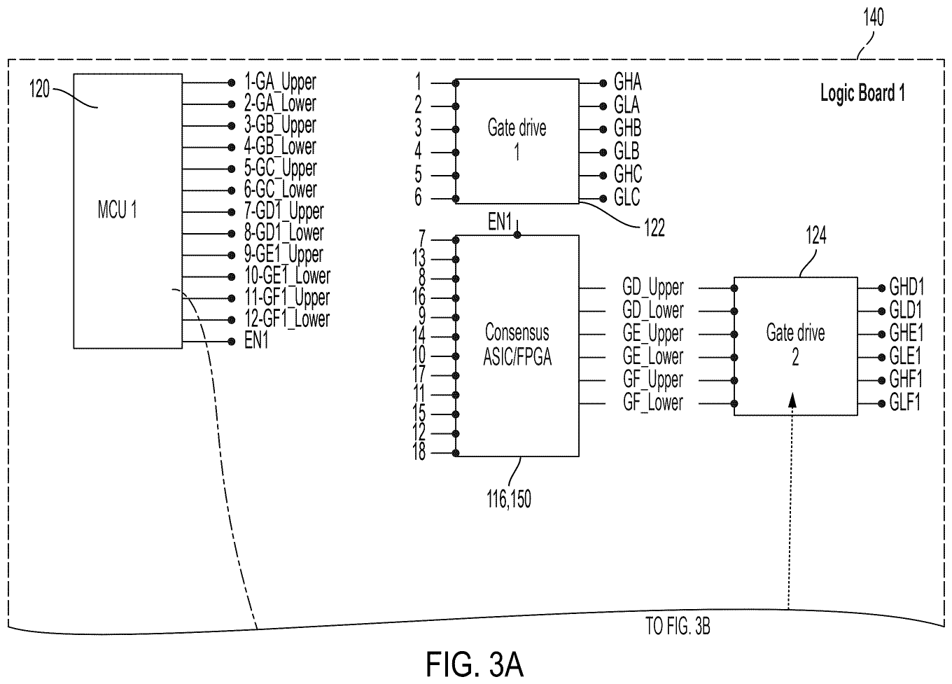

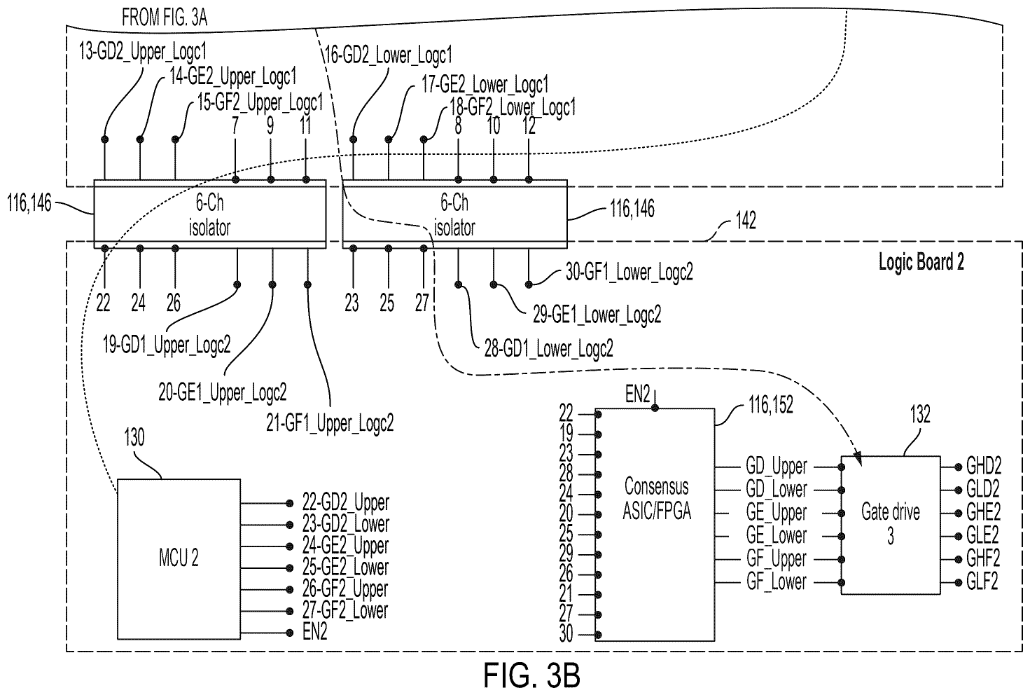

FIGS. 3A-3B show a schematic wiring diagram of two logic boards 140, 142 of the motor drive system 100 of the present disclosure. The two logic boards 140, 142 include a first logic board 140 that implements some or all components of the first ECU 110, and a second logic board 142 implements some or all components of the second ECU 112. A first 6-channel isolator 144 and a second 6-channel isolator 146 are connected between the two logic boards 140, 142 to communicate digital signals therebetween while maintaining electrical isolation between the two logic boards 140, 142. Each of the 6-channel isolators 144, 146 may include 3 digital channels in each of two opposite directions.

The primary MCU 120 is connected directly to the first gate driver 122 for supplying a first set of gate control signals, GA_Upper, GA_Lower, GB_Upper, GB_Lower, GC_Upper, GC_Lower, thereto and to thereby control operation of six corresponding output transistors in the first inverter 126.

A first consensus and arbitration controller 150 is disposed on the first logic board 140 of the first ECU 110 and is configured to supply a second set of gate control signals, GD_Upper, GD_Lower, GE_Upper, GE_Lower, GF_Upper, GF_Lower, to the second gate driver 124 and to thereby control operation of six corresponding output transistors in the second inverter 128. The first consensus controller 150 takes, as an input, a first MCU enable signal EN1 from the primary MCU 120. The first consensus and arbitration controller 150 also takes, as inputs, a first set of gate command signals, GD1_Upper, GD1_Lower, GE1_Upper, GE1_Lower, GF1_Upper, GF1_Lower, from the primary MCU 120. The first consensus controller 150 also takes, as inputs, a second set of gate command signals, GD2_Upper, GD2_Lower, GE2_Upper, GE2_Lower, GF2_Upper, GF2_Lower, from the secondary MCU 130 and as transmitted via the 6-channel isolators 144, 146.

A second consensus and arbitration controller 152 is disposed on the second logic board 142 of the second ECU 112 and is configured to supply a third set of control signals, GD_Upper, GD_Lower, GE_Upper, GE_Lower, GF_Upper, GF_Lower, to the third gate driver 132 and to thereby control operation of six corresponding output transistors in the third inverter 136. The second consensus and arbitration controller 152 takes, as an input, a second MCU enable signal EN2 from the secondary MCU 130. The second consensus and arbitration controller 152 also takes, as inputs, the second set of gate command signals, GD2_Upper, GD2_Lower, GE2_Upper, GE2_Lower, GF2_Upper, GF2_Lower, from the secondary MCU 130. The second consensus and arbitration controller 152 also takes, as inputs, the first set of gate command signals, GD1_Upper, GD1_Lower, GE1_Upper, GE1_Lower, GF1_Upper, GF1_Lower, from the primary MCU 120 and as transmitted via the 6-channel isolators 144, 146.

The first set of gate command signals, GD1_Upper, GD1_Lower, GE1_Upper, GE1_Lower, GF1_Upper, GF1_Lower, from the primary MCU 120 is connected to both of the first consensus and arbitration controller 150 and the second consensus and arbitration controller 152 to operate each of the second inverter 128 and the third inverter 136. Likewise, the second set of gate command signals, GD2_Upper, GD2_Lower, GE2_Upper, GE2_Lower, GF2_Upper, GF2_Lower, from the secondary MCU 130 is connected to both of the first consensus and arbitration controller 150 and the second consensus and arbitration controller 152 to operate each of the second inverter 128 and the third inverter 136.

The first consensus and arbitration controller 150, the second consensus and arbitration controller 152, and the 6-channel isolators 144, 146, together, comprise the gate logic switch 116. The gate logic switch 116 functions to selectively enable each of the second plurality of output switches of the second inverter 128 to be controlled by either of the primary MCU 120 or the secondary MCU 130. The gate logic switch 116 also functions to selectively enable each of the third plurality of output switches of the third inverter 136 to be controlled by either of the primary MCU 120 or the secondary MCU 130.

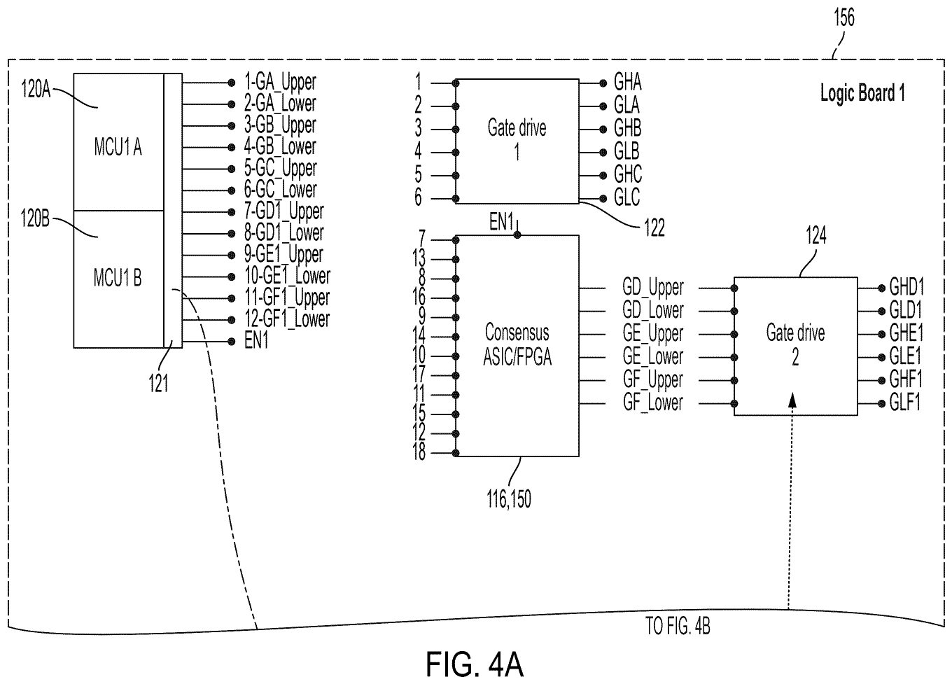

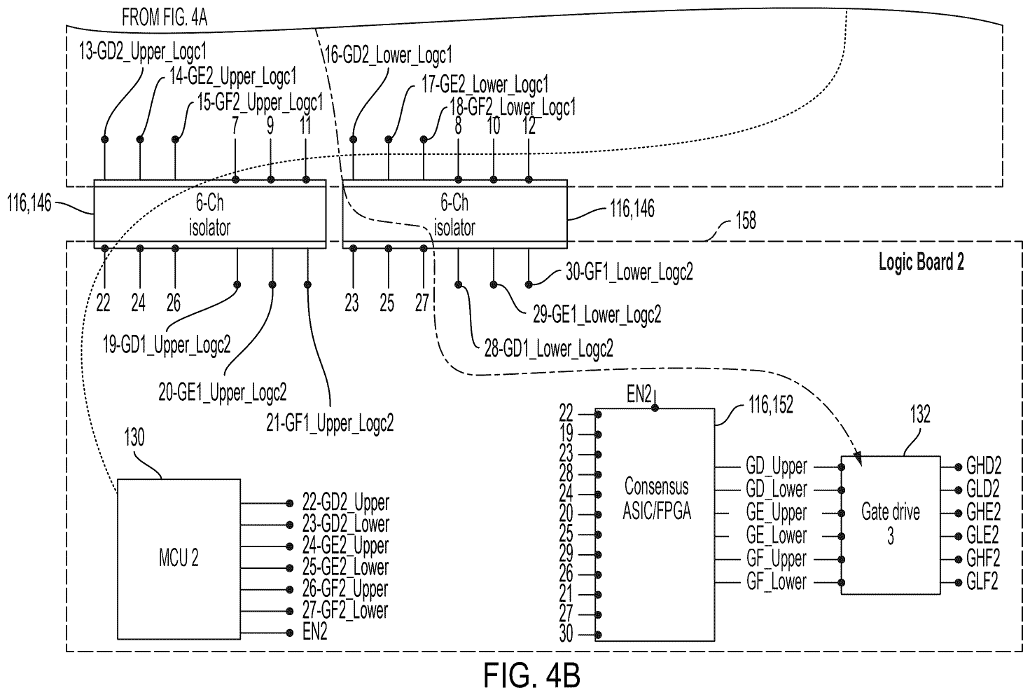

FIGS. 4A-4B show a schematic wiring diagram of two logic boards 156, 158 for the motor drive system 100 of the present disclosure. FIGS. 4A-4B show an alternative first logic board 156 and an alternative second logic board 158 that may be used in place of the first logic board 140 and the second logic board 142, respectively. The alternative first logic board 156 may implements some or all components of the first ECU 110, and the alternative second logic board 158 may implement some or all components of the second ECU 112. The two alternative logic boards 156, 158 may be similar or identical to the first logic board 140 and the second logic board 142, respectively, except the first alternative logic board 156 includes a redundant primary MCU arrangement 120A, 120B, 121 in place of the primary MCU 120 of the first logic board 140. The redundant primary MCU arrangement 120A, 120B, 121 includes a first primary MCU 120A, a second primary MCU 120B, and an output logic controller 121. The two primary MCUs 120A, 120B may operate independently, and the output logic controller 121 may monitor each of the two primary MCUs 120A, 120B to determine if either of the two MCUs 120A, 120B becomes unresponsive. The output logic controller 121 may selectively block an unresponsive one of the two primary MCUs 120A, 120B from affecting the digital output signals. Thus, the output logic controller 121 may enable either or both of the of the two primary MCUs 120A, 120B to provide the first set of gate control signals, GA_Upper, GA_Lower, GB_Upper, GB_Lower, GC_Upper, GC_Lower, and the first set of gate command signals, GD1_Upper, GD1_Lower, GE1_Upper, GE1_Lower, GF1_Upper, GF1_Lower, thereby providing redundancy between the two primary MCUs 120A, 120B.

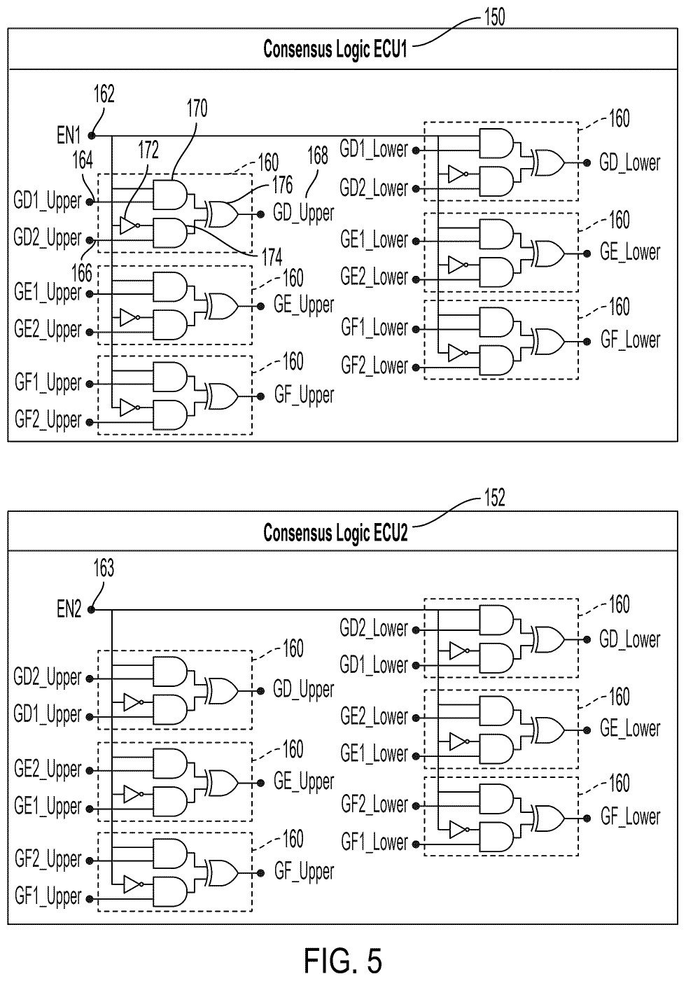

FIG. 5 shows schematic diagrams of the two consensus and arbitration controllers 150, 152. The first consensus and arbitration controller 150 includes a first plurality of six gate selectors 160. Each of the gate selectors 160 in the first consensus and arbitration controller 150 is configured to selectively enable a corresponding one of the second plurality of output switches of the second inverter 128 to be controlled by one of the primary MCU 120 or the secondary MCU 130, and as selected in response to a first MCU enable signal EN1 from the primary MCU 120. Alternatively, and if used with the redundant primary MCU arrangement 120A, 120B, 121, each of the gate selectors 160 in the first consensus and arbitration controller 150 may be configured to selectively enable a corresponding one of the second plurality of output switches of the second inverter 128 to be controlled by one of: the secondary MCU 130 or one of the first primary MCU 120A or the second primary MCU 120B, and as selected in response to the first MCU enable signal EN1 from the redundant primary MCU arrangement 120A, 120B, 121.

The second consensus and arbitration controller 152 includes a second plurality of six gate selectors 160. Each of the gate selectors 160 in the second consensus and arbitration controller 152 is configured to selectively enable a corresponding one of the third plurality of output switches of the third inverter 136 to be controlled by one of the primary MCU 120 or the secondary MCU 130, and as selected in response to a second MCU enable signal EN2 from the secondary MCU 130. Alternatively, and if used with the redundant primary MCU arrangement 120A, 120B, 121, each of the gate selectors 160 in the second consensus and arbitration controller 152 may be configured to selectively enable a corresponding one of the second plurality of output switches of the third inverter 136 to be controlled by one of: the secondary MCU 130 or one of the first primary MCU 120A or the second primary MCU 120B, and as selected in response to the second MCU enable signal EN2 from the secondary MCU 130

As shown in FIG. 5, the gate selectors 160 each define the inputs to each respective gate drivers 124 and 132. The first consensus and arbitration controller 150 also defines an enable terminal 162 that is connected to the first MCU enable signal EN1 from the primary MCU 120 and to each of the gate selectors 160. The second consensus and arbitration controller 152 also defines an enable terminal 163 that is connected to the second MCU enable signal EN2 from the dependent MCU 130 and to each of the gate selectors 160 in the first consensus and arbitration controller 152.

The first input terminals 164 of the gate selectors 160 in the first consensus and arbitration controller 150 are each connected to gate command signals from the primary MCU 120, and the second input terminal 166 of the gate selectors 160 in the first consensus and arbitration controller 150 are each connected to gate command signals from the secondary MCU 130. Each of the gate selectors 160 in the first consensus and arbitration controller 150 selectively enables the first input terminal 164 to control a respective one of the second plurality of output switches of the second inverter 128 when the first signal EN1 from the primary MCU 120 is asserted. Each of the gate selectors 160 in the first consensus and arbitration controller 150 also selectively enables the second input terminal 166 to control the respective one of the second plurality of output switches of the second inverter 128 when the signal EN1 from the primary MCU 120 is de-asserted.

The first input terminals 164 of the gate selectors 160 in the second consensus and arbitration controller 152 are each connected to gate command signals from the secondary MCU 130, and the second input terminal 166 of the gate selectors 160 in the second consensus and arbitration controller 152 are each connected to gate command signals from the primary MCU 120. Each of the gate selectors 160 in the second consensus and arbitration controller 152 selectively enables the first input terminal 164 to control a respective one of the third plurality of output switches of the third inverter 136 when the second MCU enable signal EN2 from the secondary MCU 130 is asserted. Each of the gate selectors 160 in the second consensus and arbitration controller 152 also selectively enables the second input terminal 166 to control the respective one of the third plurality of output switches of the third inverter 136 when the second MCU enable signal EN2 from the secondary MCU 130 is de-asserted.

Each of the gate selectors 160 in each of the two consensus and arbitration controllers 150, 152 may have a similar or identical construction. For simplicity of discussion only one of the gate selectors 160 is described in detail. Each of the gate selectors 160 includes a first AND gate 170 with inputs connected to the first input terminal 164 and a corresponding one of the first enable terminal 162 or the second enable terminal 163. Each of the gate selectors 160 also includes a logical inverter 172 having an input connected to the corresponding one of the first enable terminal 162 or the second enable terminal 163. Each of the gate selectors 160 also includes a second AND gate 174 with inputs connected to the second input terminal 166 and an output of the logical inverter 172. Each of the gate selectors 160 also includes an exclusive OR (XOR) gate 176 having inputs connected to outputs of the first AND gate 170 and the second AND gate 174, respectively, and defining a gate output terminal 168. The XOR gate 176 defines a corresponding one of the gate control signals, GD_Upper, GD_Lower, GE_Upper, GE_Lower, GF_Upper, GF_Lower on the gate output terminal 168.

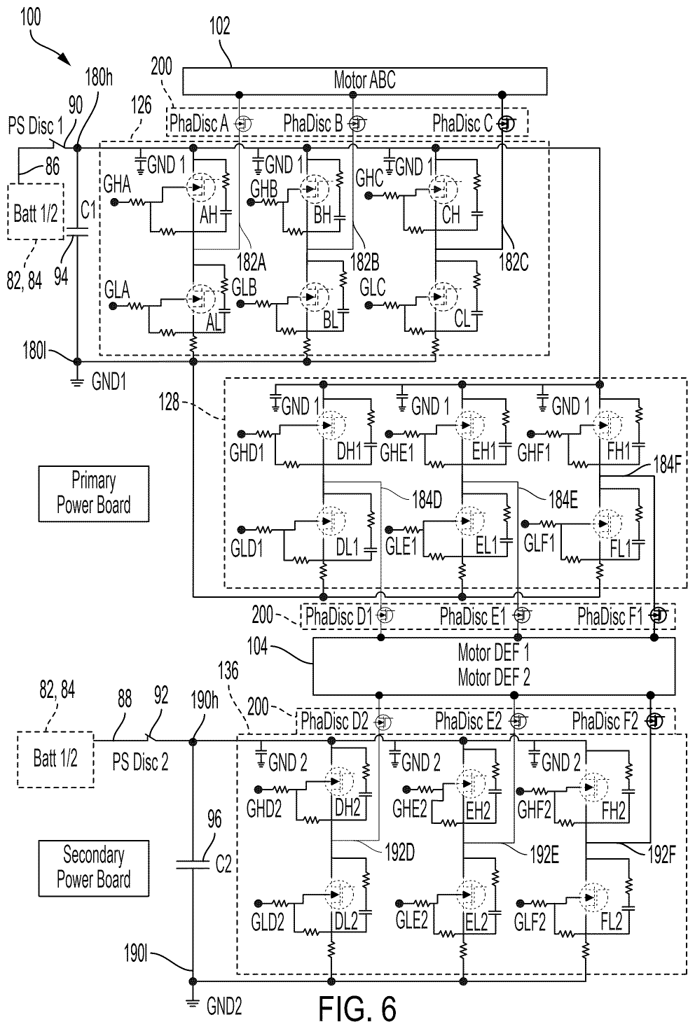

FIG. 6 shows an electrical schematic diagram showing the inverters 126, 128, 138 of the motor drive system 100 configured to supply power to the dual-wound motor 102, 104. The motor drive system 100 includes a first DC bus 180h, 1801 including a first DC high node 180h and a first DC low node 180l, with a DC voltage therebetween. The first DC low node 180l is connected to a first ground GND1, and the first DC high node 180h is connected to the first DC supply conductor 86 via a first disconnect switch 90. A first input capacitor 94 is connected across the first DC bus 180h, 180l for supplying inrush currents due to operation of the first inverter 126 and the second inverter 128.

The motor drive system 100 also includes a second DC bus 190h, 190l including a second DC high node 190h and a second DC low node 190l, with a DC voltage therebetween. The second DC low node 190l is connected to a second ground GND2, and the second DC high node 190h is connected to the second DC supply conductor 88 via a second disconnect switch 92. A second input capacitor 96 is connected across the second DC bus 190h, 190l for supplying inrush currents due to operation of the third inverter 136.

As shown, the first inverter 126 includes a first plurality of output switches AH, AL, BH, BL, CH, CL that are configured to supply a first alternating current (AC) power to the first winding set 102 of the dual-wound motor 102, 104. The first plurality of output switches AH, AL, BH, BL, CH, CL of the first inverter 126 includes an A-phase high field-effect transistor (FET) AH configured to selectively conduct current between the first DC high node 180h and an A-phase output terminal 182A that is connected to the first winding set 102 and based on an A-phase high gate signal GHA from the first gate driver 122. The first plurality of output switches AH, AL, BH, BL, CH, CL of the first inverter 126 also includes an A-phase low FET AL configured to selectively conduct current between the A-phase output terminal 182A and the first DC low node 180l and based on an A-phase low gate signal GLA from the first gate driver 122. Together, the A-phase high FET AH and the A-phase low FET AL define an A-phase driver that is operable to generate AC power on the A-phase output terminal 182A. The first plurality of output switches AH, AL, BH, BL, CH, CL of the first inverter 126 also includes similar B-phase and C-phase drivers that are configured to generate AC power on a first B-phase output terminal 182B and a first C-phase output terminal 182C, respectively.

As also shown on FIG. 6, the second inverter 128 includes a second plurality of output switches DH1, DL1, EH1, EL1, FH1, FL1 that are configured to supply a second alternating current (AC) power to the second winding set 104 of the dual-wound motor 102, 104. The second plurality of output switches DH1, DL1, EH1, EL1, FH1, FL1 of the second inverter 128 includes a first D-phase high FET DH1 configured to selectively conduct current between the first DC high node 180h and a first D-phase output terminal 184D that is connected to the second winding set 104 and based on a first D-phase high gate signal GHD1 from the second gate driver 124. The second plurality of output switches DH1, DL1, EH1, EL1, FH1, FL1 of the second inverter 128 also includes a first D-phase low FET DL1 configured to selectively conduct current between the first D-phase output terminal 184D and the first DC low node 180l and based on a first D-phase low gate signal GLD1 from the second gate driver 124. Together, the first D-phase high FET DH1 and the first D-phase low FET DL1 define a first D-phase driver that is operable to generate AC power on the first D-phase output terminal 184D. The second plurality of output switches DH1, DL1, EH1, EL1, FH1, FL1 of the second inverter 128 also includes similar first E-phase and F-phase drivers that are configured to generate AC power on a first E-phase output terminal 184E and a first F-phase output terminal 184F, respectively.

As also shown on FIG. 6, the third inverter 136 includes a third plurality of output switches DH2, DL2, EH2, EL2, FH2, FL2 that are configured to supply a third AC power to the second winding set 104 of the dual-wound motor 102, 104. The third plurality of output switches DH2, DL2, EH2, EL2, FH2, FL2 of the third inverter 136 includes a second D-phase high FET DH2 configured to selectively conduct current between the second DC high node 190h and a second D-phase output terminal 192D that is connected to the second winding set 104 and based on a second D-phase high gate signal GHD2 from the third gate driver 132. The third plurality of output switches DH2, DL2, EH2, EL2, FH2, FL2 of the third inverter 136 also includes a second D-phase low FET DL2 configured to selectively conduct current between the second D-phase output terminal 192D and the second DC low node 190l and based on a second D-phase low gate signal GLD2 from the third gate driver 132. Together, the second D-phase high FET DH2 and the second D-phase low FET DL2 define a second D-phase driver that is operable to generate AC power on the second D-phase output terminal 192D. The third plurality of output switches DH2, DL2, EH2, EL2, FH2, FL2 of the third inverter 136 also includes similar second E-phase and F-phase drivers that are configured to generate AC power on a second E-phase output terminal 192E and a second F-phase output terminal 192F, respectively.

Any or all of the output switches in the inverters 126, 128, 136 may be metal-oxide-semiconductor field-effect transistor (MOSFET) devices. However, other types of switching devices may be used, such as an insulated-gate bipolar transistor (IGBT) or another type of field-effect transistor (FET), such as a Gallium Nitride High-Electron-Mobility Transistor (GaN HEMT) or a Silicon Carbide High-Electron-Mobility Transistor (SIC HEMT). In some embodiments, the first plurality of output switches AH, AL, BH, BL, CH, CL of the first inverter 126 may have a first continuous current rating current, and the second plurality of output switches DH1, DL1, EH1, EL1, FH1, FL1 of the second inverter 128 may have a second continuous current rating that is less than the first continuous current rating. More specifically, the second plurality of output switches DH1, DL1, EH1, EL1, FH1, FL1 of the second inverter 128 may have a second continuous current rating that is one-half of the first current rating. In some embodiments, the third plurality of output switches DH2, DL2, EH2, EL2, FH2, FL2 of the third inverter 136 may have the second continuous current rating that is less than the first continuous current rating. More specifically, the third plurality of output switches DH2, DL2, EH2, EL2, FH2, FL2 of the third inverter 136 may have the second continuous current rating that is one-half of the first continuous current rating.

In some embodiments, and as shown in FIG. 6, the motor drive system 100 further includes a plurality of phase disconnects 200. Each of the phase disconnects 200 is configured to selectively conduct current between one of the inverters 126, 128, 136, and a corresponding one of the first winding set 102 or the second winding set 104 of the dual-wound motor 102, 104. The phase disconnects 200 may each include a plurality of switches, such as FETs. The phase disconnects 200 may each be controlled by a corresponding one of the primary MCU 120 or the secondary MCU 130.

The proposed primary-dependent control architecture is denoted as One-Half-and-Half (OHH) controller. The OHH naming emphasizes the fact that this controller supplies the load in three inverter power capacities: 1) one three-phase (ABC), 2) half three-phase (DEF1) and 3) another half three-phase (DEF2).

The OHH controller of the present disclosure may include the following main components: Two 6-Channel isolators. Alternatively, three 4-Ch isolators, or other combinations can be used to increase redundancy; two application specific ICs (ASIC), or field-programmable gate arrays (FPGA), denoted as “consensus and arbitration circuit”; two power inverters in the primary ECU, and one power inverter in the dependent ECU.

The isolators and the ASICs or FPGAs may be collectively named a gate logic switch (GLSWT) since they are used to transfer gate logic data from one logic domain to the other. Additionally, the inverter in the primary ECU (ECU 1) is equipped with 6 X-rated devices and 6 half-X-rated power switches, where X represents a continuous ampere rating of the power switches. Whereas the dependent ECU (ECU 2) has 6 half-X-rated switches. Since ECU 2 switches are down-sized, passive components are also down-sized, reducing the cost of ECU 2. However, the cost reduction in ECU 2 is offset by the additional power switches and one extra gate driver in ECU 1. The cost of isolators and the consensus circuit are relatively negligible. On the other hand, since ECU 2 carries only 25% of the load (continuously) and has a less important role in this architecture compared to dual ECU primary-dependent designs, further cost reductions in the choice of MCU, power switches, gate driver and other E/E components may be possible, while maintaining a given rating, such as ASIL-D.

Table 1, below, provides a comparison of hardware components to implement each of a plurality of single and redundant motor controller architectures including the one-half-and-half (OHH) redundant motor controller of the present disclosure.

TABLE 1
Single and Redundant Motor Control Architectures Comparison

| | Single | Dual | Triple | Quad | OHH |
|---|---|---|---|---|---|
| MCUs | 1 | 2 | 3 | 4 | 2 (or 3) |
| PCBs (Power/ | 1/1 | 2/2 | 3/3 | 4/4 | 2/2 |
| Logic) | | | | | |
| Gate Drivers | 1 | 2 | 3 | 4 | 3 |
| Inverter Switches | 6 | 12 | 18 | 24 | 18 |
| IMC Isolators | N/A | 1x 4-Ch | 2x 4-Ch | 2x 4-Ch | 2x 6-Ch |
| | | | | | 2x 4-Ch |
| Mot. Position ICs | 2 | 2 | 2 | 2 | 2 |
| Temperature ICs | 1 | 2 | 3 | 4 | 2 |

In the shown example, the actuator is a dual-wound PMSM which could be used in either an EPS or SbW application. However, the OHH controller of the present disclosure may be used with other types of dual-wound motors and/or with a dual-wound motor in a different application.

PTSWT is the power transfer switch. However, the presence of PTSWT is not necessary for the operation of the OHH controller and is included to provide enhanced resiliency.

The present disclosure provides a redundant primary-dependent controller design that outperforms typical dual primary-dependent controllers, while maintaining a cost/performance balance that falls between a quad and a dual-redundant architecture. The increased reliability due to more power and logic components offers a lucrative option for customers to improve fault-tolerance. Innovative factors of the OHH controller include:
Unique power board layout design using 18 MOSFETs distributed between 2 ECUs.
Unique power distribution between different inverter legs, enabling a downsized dependent ECU architecture.
Unique inter-microcontroller data sharing and gate logic consensus method between the primary and dependent ECUs.
Extra redundancy and reliability compared to typical dual-ECU architecture, with additional power and logic components with minimal cost.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A motor controller for a dual-wound motor having a first winding set and a second winding set isolated from the first winding set, said motor controller comprising:
a primary electronic control unit (ECU) including at least one primary microcontroller unit (MCU), a first inverter having a first plurality of output switches configured to supply a first alternating current (AC) power to the first winding set of the dual-wound motor, and a second inverter having a second plurality of output switches configured to supply a second AC power to the second winding set of the dual-wound motor;
a secondary ECU including a secondary MCU and a third inverter having a third plurality of output switches configured to supply a third AC power to the second winding set of the dual-wound motor; and
a gate logic switch configured to selectively enable each of the second plurality of output switches of the second inverter to be controlled by either of the at least one primary MCU or the secondary MCU and to selectively enable each of the third plurality of output switches of the third inverter to be controlled by either of the at least one primary MCU or the secondary MCU.

2. The motor controller of claim 1, wherein the gate logic switch is further configured to selectively enable each of the second plurality of output switches of the second inverter to be controlled by the at least one primary MCU in response to a first MCU enable signal from the at least one primary MCU.

3. The motor controller of claim 1, wherein the gate logic switch is further configured to selectively enable each of the third plurality of output switches of the third inverter to be controlled by the secondary MCU in response to a second MCU enable signal from the secondary MCU.

4. The motor controller of claim 1, wherein first plurality of output switches of the first inverter have a first current rating and the second plurality of output switches of the second inverter have a second current rating less than the first current rating.

5. The motor controller of claim 1, further including at least one isolator configured to communicate gate logic signals between the primary ECU and the secondary ECU, while providing electrical isolation therebetween.

6. The motor controller of claim 1, wherein the gate logic switch includes a first consensus and arbitration controller disposed in the primary ECU and a second consensus and arbitration controller disposed in the secondary ECU,
wherein the first consensus and arbitration controller includes a first plurality of gate selectors, with each gate selector of the first plurality of gate selectors configured to selectively enable a corresponding one of the second plurality of output switches of the second inverter to be controlled by one of the at least one primary MCU or the secondary MCU, and as selected in response to a first MCU enable signal from the at least one primary MCU, and
wherein the second consensus and arbitration controller includes a second plurality of gate selectors, with each gate selector of the second plurality of gate selectors configured to selectively enable each of the third plurality of output switches of the third inverter to be controlled by one of the at least one primary MCU or the secondary MCU, and as selected in response to a second MCU enable signal from the secondary MCU.

7. The motor controller of claim 1, wherein the primary ECU and the secondary ECU are each supplied power from corresponding independent direct current (DC) power sources.

8. The motor controller of claim 1, further including a power transfer switch configured to supply power to each of the primary ECU and the secondary ECU from at least one of: a first battery and/or a second battery.

9. The motor controller of claim 1, further including a plurality of phase disconnects, wherein each phase disconnect of the plurality of phase disconnects is configured to selectively conduct current between: one of the first inverter, the second inverter, or the third inverter, and a corresponding one of the first winding set or the second winding set of the dual-wound motor.

10. The motor controller of claim 1, wherein the dual-wound motor is configured to perform at least one of: applying an assist torque to a steering system of a vehicle, or controlling the steering system.

11. A motor control system comprising:
a dual-wound motor having a first winding set and a second winding set isolated from the first winding set;
a primary electronic control unit (ECU) including at least one primary microcontroller unit (MCU), a first inverter having a first plurality of output switches configured to supply a first alternating current (AC) power to the first winding set of the dual-wound motor, and a second inverter having a second plurality of output switches configured to supply a second AC power to the second winding set of the dual-wound motor;
a secondary ECU including a secondary MCU, and a third inverter having a third plurality of output switches configured to supply a third AC power to the second winding set of the dual-wound motor; and
a gate logic switch configured to selectively enable each of the second plurality of output switches of the second inverter to be controlled by either of the at least one primary MCU or the secondary MCU and to selectively enable each of the third plurality of output switches of the third inverter to be controlled by either of the at least one primary MCU or the secondary MCU.

12. The motor control system of claim 11, wherein the gate logic switch is further configured to selectively enable each of the second plurality of output switches of the second inverter to be controlled by the at least one primary MCU in response to a first MCU enable signal from the at least one primary MCU.

13. The motor control system of claim 11, wherein the gate logic switch is further configured to selectively enable each of the third plurality of output switches of the third inverter to be controlled by the secondary MCU in response to a second MCU enable signal from the secondary MCU.

14. The motor control system of claim 11, wherein first plurality of output switches of the first inverter have a first current rating and the second plurality of output switches of the second inverter have a second current rating less than the first current rating.

15. The motor control system of claim 11, further including at least one isolator configured to communicate gate logic signals between the primary ECU and the secondary ECU, while providing electrical isolation therebetween.

16. The motor control system of claim 11, wherein the gate logic switch includes a first consensus and arbitration controller disposed in the primary ECU and a second consensus and arbitration controller disposed in the secondary ECU,
wherein the first consensus and arbitration controller includes a first plurality of gate selectors, with each gate selector of the first plurality of gate selectors configured to selectively enable a corresponding one of the second plurality of output switches of the second inverter to be controlled by one of the at least one primary MCU or the secondary MCU, and as selected in response to a first MCU enable signal from the at least one primary MCU, and
wherein the second consensus and arbitration controller includes a second plurality of gate selectors, with each gate selector of the second plurality of gate selectors configured to selectively enable each of the third plurality of output switches of the third inverter to be controlled by one of the at least one primary MCU or the secondary MCU, and as selected in response to a second MCU enable signal from the secondary MCU.

17. The motor control system of claim 11, wherein the primary ECU and the secondary ECU are each supplied power from corresponding independent direct current (DC) power sources.

18. The motor control system of claim 11, further including a power transfer switch configured to supply power to each of the primary ECU and the secondary ECU from at least one of: a first battery and/or a second battery.

19. The motor control system of claim 11, further including a plurality of phase disconnects, wherein each phase disconnect of the plurality of phase disconnects is configured to selectively conduct current between: one of the first inverter, the second inverter, or the third inverter, and a corresponding one of the first winding set or the second winding set of the dual-wound motor.

20. The motor control system of claim 11, wherein the dual-wound motor is configured to perform at least one of: applying an assist torque to a steering system of a vehicle, or controlling the steering system.
